(19) United States
(12) Patent Application Publication
(10) Pub. No.: US 2011/0097610 A1
(43) Pub. Date: Apr. 28, 2011

(54) Energy storage device

(75) Inventors: Walter Rau, Stuttgart (DE); Ronny Gopfert, Oederan (DE)

(73) Assignee: VOITH PATENT GMBH (GERMANY)

(21) Appl. No.: 12/807,844

(22) Filed: Sep. 14, 2010

(30) Foreign Application Priority Data
Oct. 28, 2009 (DE) 102009050960.7

(51) Int. Cl. H01M 10/50

(52) U.S. Cl. 429/50; 429/120

(57) ABSTRACT

An energy storage device is constructed from a plurality of supercap cells. In each case, some of these supercap cells are interconnected electrically to a storage module. Each of the storage modules is disposed in a housing. The individual supercap cells are in at least indirect heat-conducting contact with the housing. A plurality of the housings are stacked above one another or adjacent to one another such that a fluid can flow through at least partial regions between the housings.

The invention relates to an energy storage device having the features in the characterising part of the preamble of claim 1 and the use of such an energy storage device.

Energy storage devices, which are constructed of supercap cells or high-power capacitor cells are known per se from the general prior art. Such energy storage devices can be used, for example, for the intermediate storage of energy particularly when this occurs as electrical power having comparatively high currents. One scenario for the use of such energy storage devices can, for example, be the hybridisation of an omnibus with a diesel-electric drive. When braking and re-accelerating such an omnibus having a comparatively large mass, a very high electrical braking power is produced or a comparatively high electrical power is required for acceleration. In order to be able to store and re-use this as far as possible free from losses, supercap cells are particularly well-suited for the energy storage devices since these have a lower internal resistance and therefore lower power losses compared with batteries.

Conventional energy storage devices comprising a plurality of supercap cells are typically constructed so that in each case, some of the supercap cells are electrically connected to a storage module, the individual storage modules then forming the energy storage device or being connected to said device. It is known from the general prior art that the supercap cells of the individual storage modules are disposed in their own housings. In these housings they are then typically, at least indirectly, in heat-conducting contact with the housing so that a flow of air around the housing, for example, with wind created whilst travelling, ensures a certain cooling of the supercap cells when used in hybrid vehicles. In order to provide the required cooling power, in conventional superstructures however, the wind created whilst travelling is frequently not sufficient. Therefore it is also known from the general prior art that each of the housings of the individual storage modules additionally has an electrically driven fan. This fan provides for forced flow around the housing and can therefore improve the cooling of the individual storage modules and therefore ultimately the cooling of the entire energy storage device.

Now, the structure of individual housings each having their own fans is comparatively expensive and results in a very complex structure of the energy storage device. The energy storage device typically has a plurality of individual fastening elements and in particular a plurality of cables via which the electrical interconnection of the individual modules to one another and to the requisite electronics is accomplished. In addition, the fact that its own fan can be provided for each housing again significantly increases the complexity and the number of requisite cables. All in all, this results in a structure which is extraordinarily complex in regard to assembly and maintenance. Additionally, if such a structure is used in a hybrid vehicle, for example, mounted on the roof of a hybridised omnibus, a large amount of dirt can accumulate very rapidly in the very complex structure comprising a tangle of leads and cables, which on the one hand adversely affects the cooling of the individual housings of the storage modules, can clog the fans and overall promotes the accumulation of dirt in this region. Such accumulations of dirt and the fact that the complex leads interconnecting the structure are possibly exposed to the weather, can very easily lead to a functional impairment of the energy storage device. In addition, cables disposed in the area of vehicles can easily be detached from their fastenings by dirt and weather influences as well as by vibrations of the vehicle and are then damaged by chafing.

It is the object of the present invention here to provide an energy storage device of the type specified above which obviates the disadvantages described and provides a very simple and neat energy storage device in regard to assembly, having a simple and cost-effective structure, which additionally ensures ideal conditions for the cooling of the supercap cells contained therein.

This object is achieved according to the invention by the features in the characterising part of claim 1.

According to the invention, a plurality of the housings are stacked above one another or adjacent to one another such that a fluid, i.e. a liquid or in particular gaseous medium, can flow through at least partial regions between the housings. This stacking of the housings adjacent to one another or above one another, either abutting against one another or spaced apart from one another in partial regions, allows a structure which can be achieved mechanically very easily and which allows a fluid, for example, the wind produced whilst travelling of a hybrid vehicle fitted with the energy storage device, to flow through the intermediate regions of the housing. Thus, a compact and simple structure is produced which can be ideally cooled by the through-flowing property.

In another very favourable and advantageous embodiment of the energy storage device according to the invention, it is additionally provided that in the stacking directions the housings have a profile which is substantially corrugated or consists of successive protuberances. Such a profile is ideally suited for surrounding the individual supercap cells which are typically configured as round cells. In addition, when stacking the housing with such profiles, which is typically accomplished such that a corrugated bulge or protuberance in the neighbouring module also impinges upon a corrugated bulge or protuberance of its housings, free spaces are formed between the corrugated bulges or protuberances which are suitable for the cooling fluid to flow therethrough.

In another very favourable and advantageous embodiment of the energy storage device according to the invention, it is additionally provided that in the stacking direction the housings each comprise only one supercap cell. The supercap cells of the individual storage modules are therefore disposed transverse to the stacking direction so that the thickness of the housing of the respective storage module in the stacking directions in each case only comprises one storage cell. It is thus ensured that this supercap cell can be ideally cooled from both sides of the housing by the cooling fluid stream flowing at least in partial regions between the housings.

In another very favourable and advantageous embodiment of the energy storage device according to the invention, it is further provided that the housings of the storage modules comprise a good heat-conducting material, in particular an aluminium-based material. As a result of this use of aluminium material, the corresponding partial regions can be manufactured of aluminium or an aluminium alloy very simply in the form of aluminium profiles or aluminium sheets. In particular, die cast profiles or extruded profiles of aluminium can be used simply and efficiently for the structure of the housing as a simple and cost-effective material having a high thermal conductivity.

In another very favourable and advantageous embodiment of the structure of an energy storage device according to the invention, it is further provided that the housings are at least partially filled with a heat-conducting potting compound or a heat-conducting oil and are tightly sealed. This use of an electrically insulating, heat-conducting potting compound or an electrically insulating, heat-conducting oil ensures that the supercap cells disposed in the storage modules are electrically insulated with respect to one another and with respect to electronic components which may also be disposed in the housing. In addition, a good thermal conductivity is ensured by the potting compound or the oil since heat can be removed from the region of the supercap cells directly by heat conduction and no insulating air gaps or the like need to be overcome. The potting compound can be designed to that the housing is partially or completely potted. The introduction of the potting compound in the form of mats is also feasible.

In another very favourable and advantageous embodiment of the energy storage device according to the invention, the housings are constructed from two sheet metal parts which are substantially corrugated or provided with successive protuberances, which sheet metal parts are connected on the longitudinal side by U profiles and are sealed on the front sides by means of cover elements, in particular made of plastic. This structure of two metal sheets or sheet metal elements which are substantially corrugated or provided with successive protuberances, into which circular-section-shaped regions are incorporated at a certain distance from one another for receiving the individual supercap cells is correspondingly simple and efficient. Such metal sheets can be manufactured as bulk good, for example, made of aluminium or another metal. These are then connected to one another on the longitudinal side by U profiles, which can also be accomplished comparatively simply since the metal sheets have a flat termination on the longitudinal side which can be gripped simply and efficiently by means of U profiles. On the front sides which have a comparatively complex shape as a result of the mutually facing profile of the two metal sheets, it is then possible to use cover elements which are formed in particular of plastic and can be produced simply and cost-effectively by injection moulding.

In a preferred manner, assembly can be carried out in this case such that one of the sheet metal parts is placed on a corresponding underlayer and is loaded with supercap cells in the region of its protuberances. These are then connected to one another and possibly to electronics disposed in the region of the housing. The second metal sheet can then be placed thereon from above. The two metal sheets can then be braced to one another on the two longitudinal sides by means of the U profiles. To this end, possibly an adhesive, a welding process or the like can be used to seal the housing at the seam between the metal sheets and the U profiles. The housing can then be erected and connected or glued to a cover on one side. A cover can then also be attached to the other side, in particular after the housing, according to a preferred further development, has been filled with a thermally conducting but electrically insulating oil.

In another particularly favourable and advantageous embodiment of the structure of the energy storage device, it is further provided that the housings comprise a plurality of supercap cells and at least one electronics unit for cell voltage compensation for these supercap cells. This structure in which the electronics is integrated in each of the storage modules enormously simplifies the structure and cabling of the storage modules. In particular, the electronics for cell voltage compensation which must be provided with terminals for the individual cells, is ideally suited for such integration since this can eliminate a plurality of cables and connecting elements which in a conventional structure would need to be guided outside the housing.

In another very favourable and advantageous structure, it is additionally intended that the storage modules are combined with a central electronics unit to form a module stack. This structure in which the individual storage modules are combined with a central electronics unit disposed, for example, at the centre or at the side of the stack, allows a very simple and compact structure in which the energy storage device can easily be handled and inserted.

In another very favourable and advantageous embodiment hereof, it is further provided that the storage modules are electrically connected to one another by means of an electrical rail system. In such a structure, in particular of a central electronics unit is integrated with the stack, a stack can be created very easily and efficiently, this stack being interconnected via the electrically conducting rails of the rail system. The stack in its entirety then merely needs to be connected by means of a very few external connections to a corresponding unit for supplying and/or removing power, for example, an inverter or the like.

In another very advantageous embodiment, it is additionally provided that the stack of the storage modules comprises an external housing which is open in at least two directions transverse to the stack. In this embodiment, the stack is therefore integrated in an external housing which on the one hand facilitates the handling of the energy storage device as a unit, in particular with an integrated central electronics unit. In addition, the external housing is configured such that it is open in two opposite directions transverse to the stacking direction and consequently the flow of cooling fluid through the intermediate spaces between the individual housings is not adversely affected. In addition to the ideal coolability, a very compact and easy-to-handle structure is thus achieved.

In another very favourable and advantageous embodiment of the energy storage device according to the invention, at least one fan can additionally be provided, via which a fluid flow can be forced between the housings. In a particularly preferred further development, fewer fans are provided than there are storage modules in the stack. Unlike the structure from the prior art, few fans, or preferably only one fan, are sufficient, which fans can intensify the flow of cooling fluid through the housings if necessary or maintain this flow, for example, when a hybridised vehicle fitted with the energy storage device is at a standstill.

The structure of the energy storage device according to the invention thus allows a very compact and simple and efficient structure in regard to assembly and cabling, which can be ideally cooled. This predestines the energy storage device for the use according to the invention in a vehicle, in particular in an omnibus, wherein the housing of the storage modules is cooled by wind produced whilst travelling and an optional fan. The structure can therefore be used ideally in the outer region of a vehicle or an omnibus. In particular, it can be mounted simply and efficiently on a corresponding underframe and can thus be placed, for example, together with an inverter, on the roof of an omnibus to serve as an energy storage device for the hybridised drive train of such a vehicle.

Further advantageous embodiments of the energy storage device according to the invention are obtained from the exemplary embodiment which is described in detail hereinafter with reference to the figures.

In the figures:

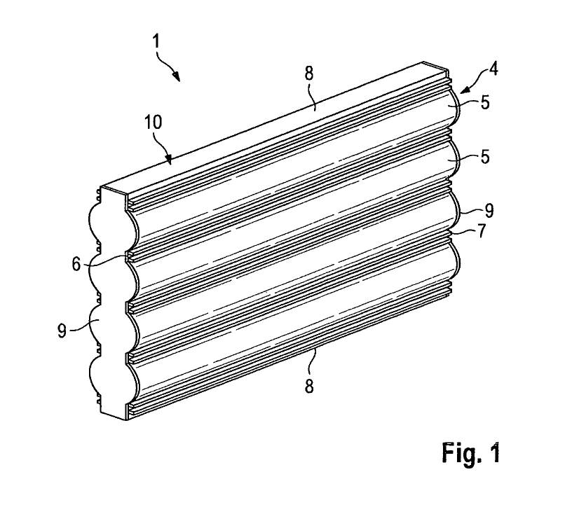

FIG. 1 shows a three-dimensional view of a possible structure of a storage module;

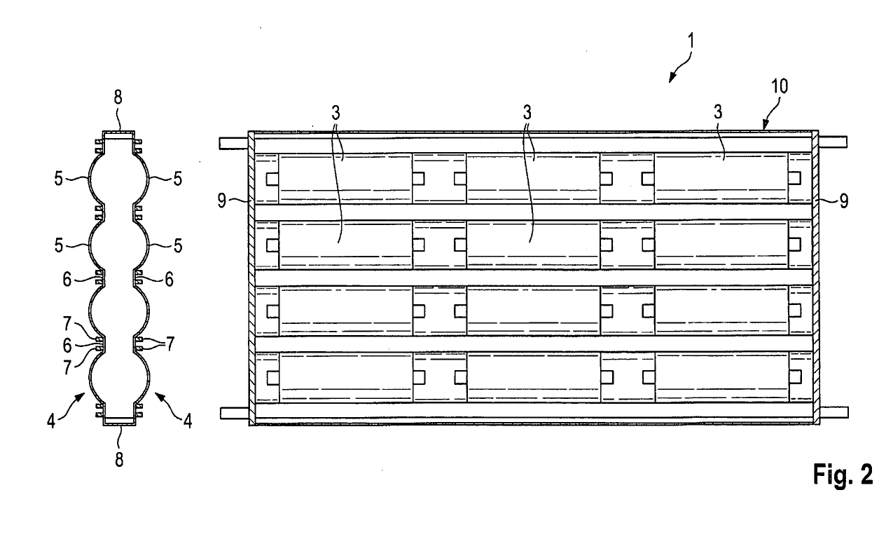

FIG. 2 shows a diagram of the storage module in cross-section and longitudinal section; and

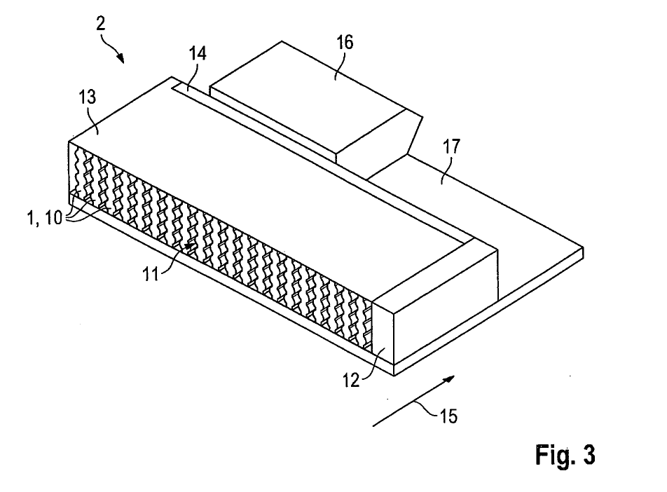

FIG. 3 shows a possible structure of an electrical energy storage device according to the invention.

The diagram in FIG. 1 shows a three-dimensional view of an exemplary structure of a storage module 1 of an electrical energy storage device 2 shown in its entirety in FIG. 3. The storage module 1 comprises a plurality of supercap cells 3 which can be seen in the sectional view in FIG. 2. As can be seen from a combined view of FIGS. 1 and 2, the storage module 1 consists of two lateral substantially corrugated sheet metal parts 4 which comprise a coarsely corrugated profile of successive protuberances 5. This profile can be seen in detail in the diagram in FIG. 2. In the exemplary embodiment shown here, this consists of four protuberances 5 between which a short straight section 6 is disposed. In addition, two fins 7 are disposed in the region of this straight section. The two sheet metal parts 4 are then arranged with respect to one another such that the protuberances 5 are each disposed at the same height. Thus, respectively one supercap cell 3 can be accommodated between two protuberances 5 in the transverse direction to the protuberances 5. As can be seen in the diagram in FIG. 2, a plurality of supercap cells 5 can be arranged one after the other in the direction of the protuberances 5. In addition to the supercap cells 3, electronic modules can also be integrated in the storage module 1, in particular an electronics unit for cell voltage compensation between the individual supercap cells 3 of the respective storage module 1.

The sheet metal parts 4 are then connected my means of respectively one U-shaped profile 8 above the uppermost row of supercap cells 3 and below the lowermost row of supercap cells 3. These U-shaped profiles 8 can, in the same way as the sheet metal parts 4, be manufactured in a particularly simple and cost-effective manner from aluminium. In particular, an aluminium extruded profile such as is available commercially on the market can be used for the U profile 8. A comparable profile can also be used for the sheet metal parts 4. The aluminium alloy of the components has the crucial advantage in this case that this ensures very good heat conduction at comparatively favourable cost.

As can be seen in the diagram in FIG. 1, the storage module 1 is sealed with respect to the environment. This is accomplished in the structure described previously, for example, by adhesively bonding or welding the sheet metal parts 4 to the U profiles 8. At the front sides of the storage module which are now still open, this is sealed by means of cover elements 9 which can be manufactured simply and cost-effectively from a plastic for example, as an injection moulding. Since the cover elements 9 have a comparatively complex shaping, this fabrication process and the manufacture from plastic is very simple and efficient. As a result of the sheet metal parts 4 made of aluminium, sufficient heat conduction of the storage module 1 towards the outside is ensured. This structure described previously and shown in FIGS. 1 and 2 therefore now has a single storage module 1 with its housing 10 constructed from the sheet metal parts 4, the U profiles 8 and the cover elements 9. This housing 10 now comprises the supercap cells 3 and possibly an electronics unit for cell voltage compensation, not shown here, and possibly further electronic components. In order to ensure ideal heat conduction from the individual supercap cells 3 to the housing 10 or the sheet metal parts 4 and the U profiles 8, during or after assembly and before the final sealing, for example by the second cover element 9, the housing can either be partially or completely potted using an electrically insulating and good heat-conducting potting compound, in particular in the form of mats, or it can be filled with oil having comparable properties. This filling with oil or heat-conducting potting compound ensures that the individual supercap cells 3 are connected to the sheet metal parts 4 and the U profile 8 in a heat-conducting manner and thus very good heat conduction is ensured between the individual supercap cells 3 and the housing 10 without this being hindered by insulating air gaps.

In the diagram in FIG. 3 it can now be seen that the individual storage modules 1 with their housing 10 are stacked to form a module stack 11. The individual housings 10 of the storage modules 1 are in this case stacked adjacent to one another or above one another so that these are either stacked one above the other in a spaced manner so as to ensure space between the individual housings 10 for cooling fluid to flow therethrough, for example the air flow approaching the vehicle due to the dynamic pressure or the wind produced whilst travelling. As a result of the substantially corrugated configuration of the sheet metal parts 4, these can also be stacked directly onto one another since air can flow in the region of the straight sections 6 and in particular in the region of the fins 7 in any case even if the individual housings 10 are in contact in the region of the protuberances 5. The fins 7 ensure ideal heat removal to the flowing cooling fluid.

In the diagram in FIG. 3 it can additionally be seen that the module stack 11 is stacked together with an electronics unit 12 as central electronics for the energy storage device 2 to form the module stack 11. For example, the electronics unit 12 is in this case disposed at one end of the module stack 11, it can also be placed at the centre or at any other point in the module stack 11. The individual storage modules 1 of the module stack 11 are connected to the central electronics 12 by means of an electrical rail system which cannot be seen here. This ensures a simpler and secure electrical connection of the individual storage modules 1 of the module stack 11 to one another without complex cabling or the like being required. The module stack 11 comprising the individual storage modules 1 and the central electronics 12 is then surrounded by an external housing 13 so that an easy-to-handle electrical energy storage device is produced. In this case, the external housing 13 is only closed on four sides of the module stack 11 and leaves two opposing sides free so that the flow of cooling fluid through the intermediate spaces between the housings of the individual storage modules 1 is ensured and is not hindered by the external housing 13. In the structure of the electrical energy storage device 2 shown here, this additionally comprises an optional fan 14 which is likewise merely indicated in the diagram in FIG. 3. This fan 14, if necessary there can also be a plurality of fans if appropriate in which case in particular very few fans 12 are sufficient, can be operated as required to force a higher volumetric flow of cooling fluid through the intermediate spaces between the individual housings 10 of the storage modules 1 and thus improve the cooling by means of forced convection. In this case few fans 14 are to be understood as fewer fans per module stack 11 than the module stack 11 has individual storage modules 1.

In the preferred intended usage of the electrical energy storage device 2 for the intermediate storage of energy accumulating in particular during braking in a hybridised drive train of a vehicle, in particular an omnibus, the structure, as can be seen in the diagram in FIG. 3, can be constructed so that the two opposing open sides of the external housing 13 are arranged so that wind produced whilst travelling can flow through according to the direction indicated by the arrow 15. The optional fan 14 then only needs to be switched on if the cooling with the wind produced during travelling is not sufficient, for example, at high ambient temperature and/or slow travel or when the vehicle is stationary. The structure of the energy storage device 1 according to FIG. 3 is arranged together with an inverter 16, indicated schematically, on a frame or a platform 17. This can then be mounted, for example, on the vehicle roof of a vehicle, in particular an omnibus. The structure is accordingly simple and has little complexity with regard to the cabling. It is accordingly cost effective to maintain. It can be constructed on a suitable surface of the frame or the platform 17 regardless of the type of vehicle to which it is fitted, the width of the stack and therefore the number of storage modules 1 located in the module stack 11 allowing simple scaling with regard to the desired storage capacity. The underside of the frame or the platform 17 can then be configured individually to fit the respectively desired vehicle so that the structure shown in FIG. 3 can be adapted simply and efficiently, for example to the roof superstructures of various omnibuses from different manufacturers without the structure needing to be changed per se. This ensures simple and efficient use for series production of electrical energy storage devices for various types of vehicle or omnibus.

1-13. (canceled)

14. An energy storage device comprising:
a plurality of supercap cells,
of which at least some are interconnected electrically to a storage module, wherein
each of the storage Modules is disposed in a housing, wherein
the individual supercap cells are disposed in at least indirect heat-conducting contact with the housing,
characterized in that
a plurality of the housings are stacked above one another or adjacent to one another such that a fluid can flow through at least partial regions between the housings.

15. The energy storage device according to claim 14, characterized in that in the stacking direction the housings have a profile which is substantially corrugated or consists of successive protuberances.

16. The energy storage device according to claim 14, characterized in that in the stacking direction the housings each comprise only one supercap cell.

17. The energy storage device according to claim 15, characterized in that in the stacking direction the housings each comprise only one supercap cell.

18. The apparatus according to claim 14, characterized in that the housings of the storage modules comprise a good heat-conducting material, in particular an aluminum-based material.

19. The apparatus according to claim 15, characterized in that the housings of the storage modules comprise a good heat-conducting material, in particular an aluminum-based material.

20. The apparatus according to claim 16, characterized in that the housings of the storage modules comprise a good heat-conducting material, in particular an aluminum-based material.

21. The apparatus according to claim 17, characterized in that the housings of the storage modules comprise a good heat-conducting material, in particular an aluminum-based material.

22. The energy storage device according to claim 14, characterized in that the housings are at least partially filled with heat-conducting potting compound or heat-conducting oil and are tightly sealed.

23. The energy storage device according to claim 15, characterized in that the housings are at least partially filled with heat-conducting potting compound or heat-conducting oil and are tightly sealed.

24. The energy storage device according to claim 16, characterized in that the housings are at least partially filled with heat-conducting potting compound or heat-conducting oil and are tightly sealed.

25. The energy storage device according to claim 17, characterized in that the housings are at least partially filled with heat-conducting potting compound or heat-conducting oil and are tightly sealed.

26. The energy storage device according to claim 14, characterized in that the housings are constructed from two sheet metal parts which are substantially corrugated or provided with successive protuberances, which sheet metal parts are connected on the longitudinal side by U profiles and are sealed on the front sides by means of cover elements, in particular made of plastic.

27. The energy storage device according to claim 14, characterized in that the housings comprise a plurality of supercap cells and at least one electronics unit for cell voltage compensation for these supercap cells.

28. The energy storage device according to claim 14, characterized in that the storage modules are combined with a central electronics unit to form a module stack.

29. The energy storage device according to claim 14, characterized in that the storage modules are electrically connected to one another by means of an electrical rail system.

30. The energy storage device according to claim 29, characterized in that the module stack of the storage modules comprises an external housing which is open in at least two directions transverse to the stack.

31. The energy storage device according to claim 14, characterized in that at least one fan is provided, via which a fluid flow, in particular an air flow can be forced between the housings.

32. The energy storage device according to claim 31, characterized in that fewer fans are provided than storage modules disposed in the module stack.

33. Use of an energy storage device for a vehicle, in particular an omnibus, wherein the housing of the storage modules is cooled by wind produced whilst traveling and an optional fan.
